(19) United States
(12) Patent Application Publication
(10) Pub. No.: US 2018/0306110 A1
(43) Pub. Date: Oct. 25, 2018

(54) ENGINE

(71) Applicant: Amnext Technology Inc., Kanagawa (JP)

(72) Inventor: Yasutoshi OHISHI, Kanagawa (JP)

(21) Appl. No.: 15/768,455

(22) PCT Filed: Oct. 14, 2016
(86) PCT No.: PCT/JP2016/080574

§ 371 Date: Apr. 13, 2018

(30) Foreign Application Priority Data
Oct. 16, 2015 (JP) 2015-204806

(51) Int. Cl. F02C 5/02; F02C 5/08; F02C 9/18; F23R 7/00

(52) U.S. Cl. CPC F02C 5/02; F23R 7/00; F02C 9/18; F02C 5/08

(57) ABSTRACT

There is provided an engine (10) including a gas turbine unit and a plurality of combustion units (80) that supplies combustion gas (51) to the gas turbine unit. Each of the combustion units (80) includes: a combustion chamber (11); a first mechanism (71) that moves a first wall surface (81a) that configures a part of the combustion chamber, using an elastic force of a spring (83) to reduce a volume of the combustion chamber (11) and pressurize a gas (58) inside the combustion chamber; and a second mechanism (72) that opens and closes an exhaust port (85) of the combustion chamber to control the timing at which combustion gas (51) is discharged from the exhaust port.

### TECHNICAL FIELD

The present invention relates to an engine that drives a turbine using combustion product gas that has been intermittently burned in a combustion chamber.

### BACKGROUND ART

Japanese Laid-open Patent Publication No. 2005-207359 discloses a power generating system that intermittently detonates fuel for explosive combustion which is accompanied by shock waves, and uses the energy produced by detonation as a driving force for generating electricity. A pulse-detonation engine power generating system includes a detonation tube with a cylindrical cavity of a predetermined length in which detonation occurs, feeds gas at predetermined intervals inside the detonation tube, and also supplies fuel at predetermined intervals inside the detonation tube. The fuel is ignited to produce impact energy inside the detonation tube, and this energy is guided to a turbine to drive the turbine and generate electricity. The supplying of gas to the detonation tube is excessive to produce a cold flow for intermittent cooling. The system also has a shock damper that uses gas pressure to dampen the impact energy.

### SUMMARY OF INVENTION

A detonation engine is an engine that uses “detonation”, i.e., the transmission of combustion waves, which is theoretically very efficient. However, it is important how the detonation waves are formed in the combustion chamber and then transmitted. This means that there are many issues, such as the selection of fuel, the ignition method, the intake process, and the shape of the combustion chamber. Although a detonation engine has a seemingly simple configuration, it is difficult to realize a compact and highly efficient engine capable of achieving stable performance.

One aspect of the present invention is an engine including a gas turbine unit and a plurality of combustion units that supply combustion gas to the gas turbine unit. Each of the plurality of combustion units includes: a combustion chamber; a first mechanism that moves a first wall surface that constructs a part of the combustion chamber using an elastic force to reduce a volume of the combustion chamber and pressurize gas inside the combustion chamber; and a second mechanism that opens and closes an exhaust port of the combustion chamber to control timing at which the combustion gas is discharged from the exhaust port. These combustion units compress the gas inside the combustion chamber adiabatically by reducing the volume of the combustion chamber with the first mechanism using an elastic force, typically a spring. Accordingly, it is possible to increase the compression ratio of the gas inside the combustion chamber with an extremely simple mechanism. The gas inside the combustion chamber may be a mixed gas composed of fuel and air, and may be ignited using an igniter or the like in a compressed state. The gas inside the combustion chamber may be air, and fuel may be injected to perform compression ignition.

In addition, using the second mechanism, it is possible to control the timing at which the combustion gas, after the ignition, is discharged (ejected) and possible to control the timing for supplying combustion gas to the turbine unit and the pressure inside the combustion chamber during combustion. In addition, in these combustion units, it is possible to repeat combustion in a short period composed of two cycles and to supply combustion gas to the turbine unit with a constant load of a sufficient magnitude to move against the elastic force that drives the first mechanism.

This means that it is possible to arrange a plurality of combustion units with a simple configuration with respect to a turbine unit and to supply the combustion gas to the turbine unit with short multiple cycles at different timings from the plurality of combustion units. Accordingly, with this engine, on the combustion sides, as the intermittent combustion, it is possible to raise the combustion temperature in the same way as the Otto cycle, the diesel cycle, or the Sabathe cycle, and possible to supply the combustion gas pseudo-continuously with short cycles from the plurality of combustion units to a gas turbine unit, which makes it possible to drive the gas turbine unit with high efficiency.

In each combustion unit, it is possible to provide the exhaust port on a movement path of the first wall surface, for example, the piston, and possible for the first mechanism to serve as the second mechanism. The combustion unit may include a third mechanism that holds a position of the first wall surface against (to resist) the elastic force. The movement of the first wall surface can be fixed in a state where the volume of the combustion chamber has expanded due to the combustion pressure, and it is possible to discharge and supply air in that state. The combustion units may each include a fourth mechanism that holds the position of the first wall surface against (to resist) the pressure inside the combustion chamber. It is possible to make the combustion in the combustion chamber approach constant-volume combustion and further raise the combustion temperature, and to raise the combustion efficiency after causing combustion ignition by injecting fuel.

The plurality of combustion units may each include a fifth mechanism that moves the first wall surface against the elastic force in a direction where the volume of the combustion chamber expands. The fifth mechanism also functions as a starter. In addition, it is possible to further include an electric actuator that drives the fifth mechanism and an energy regeneration mechanism that generates electrical power using the electric actuator when the engine is running. The engine may also include a mechanism that drives the respective fifth mechanisms of the plurality of combustion units independently. The plurality of combustion units may each include a piston that moves inside the combustion chamber and is equipped with the first wall surface that faces the combustion chamber. Although it is possible to drive the pistons of the plurality of combustion units in concert when the engine starts or the like, it is also possible to control combustion in the individual combustion chambers independently by independently moving the pistons of the combustion units using a means that supplies the elastic force, such as a spring, and an electrical actuator or the like.

A combustion unit may also include a gas supplying system for temporarily storing compressed gas, which is to be supplied to the combustion chamber, in a region on an opposite side of the piston to the combustion chamber. By storing compressed gas, for example combustion air or a mixed gas, before supplying to the combustion chamber temporarily in a region on the opposite side of the piston to the combustion chamber, there is a fall in the pressure difference between the spaces (regions) before and after the piston, that is, between the combustion chamber and the region on the opposite side, so that when the pressure in the combustion chamber increases due to combustion, it is possible for the region on the opposite side to the piston to act together with the first mechanism to bear this pressure. When the piston is moved to further compress the gas inside the combustion chamber, the pressure before and after the piston becomes substantially balanced, which makes it easier to move the piston with an elastic body, such as a spring.

Each of the plurality of combustion units may include a critical nozzle that connects the combustion chamber and the gas turbine unit, and the second mechanism may intermittently open and close a passage between the combustion chamber and a throat part of the critical nozzle. By connecting the combustion chamber and the critical nozzle (or “supersonic nozzle” or “de Laval nozzle”) via the second mechanism that functions as a back pressure control unit, it is possible to control the pressure with which the combustion gas intermediately produced in the combustion chamber flows into the throat part of the critical nozzle. In addition, since it is possible to start intermediate combustion in the combustion chamber in a state where the combustion chamber is separated from the critical nozzle by the second mechanism, it is easy to control the combustion inside the combustion chamber.

The gas turbine unit may include a radial turbine unit and the plurality of combustion units may be arranged around a circumference of the radial turbine unit. A power generating apparatus including the engine described above and a generator connected to the gas turbine unit is also included in the present invention.

### BRIEF DESCRIPTION OF DRAWINGS

FIG. 1 depicts one example of a power generating apparatus including an engine, where FIG. 1(a) depicts an overview of the configuration when looking from above and FIG. 1(b) depicts an overview of the configuration when looking from the side.

FIG. 2 depicts the overall configuration of a combustion unit, where FIG. 2(a) depicts a state where a piston is positioned near the top and FIG. 2(b) depicts a state where the piston is positioned near the bottom.

FIG. 3(a) depicts one example of a stopper and FIG. 3(b) depicts another example of a stopper.

FIG. 4 depicts an overview of a different combustion unit.

FIG. 5 depicts an overview of yet another combustion unit.

FIG. 6 depicts an overview of yet another combustion unit, where FIG. 6(a) depicts a state where a back pressure control unit has intermittently closed a passage between a combustion chamber and a throat portion of a critical nozzle and FIG. 6 (b) depicts a state where the back pressure control unit has intermittently opened the passage between the combustion chamber and the throat portion of the critical nozzle.

FIG. 7 depicts an overview of yet another combustion unit, where FIG. 7(a) depicts a state where a back pressure control unit has intermittently closed a passage between a combustion chamber and a throat portion of a critical nozzle and FIG. 7(b) depicts a state where the back pressure control unit has intermittently opened the passage between the combustion chamber and the throat portion of the critical nozzle.

FIG. 8 depicts an overview of yet another combustion unit.

FIGS. 9(a) and 9(b) depict overviews of other combustion units.

FIG. 10 is a block diagram depicting an example of a power generating apparatus including a different engine.

FIG. 11 depicts an overview of another combustion unit.

FIG. 12 depicts an overview of an engine including a plurality of combustion units, where FIG. 12(a) is a perspective view, FIG. 12(b) is a rear view, FIGS. 12(c) and (d) depict first and second opening/closing panels, and FIGS. 12(e) and (f) depict a state where the combustion chamber is opened and closed by these opening/closing panels.

FIG. 13 depicts an overview of another engine.

FIG. 14 depicts an overview of yet another combustion unit, where FIG. 14(a) depicts a state where a back pressure control unit has intermittently closed a passage between a combustion chamber and a throat portion of a critical nozzle, FIG. 14(b) depicts a state where the back pressure control unit has intermittently opened the passage between the combustion chamber and the throat portion of the critical nozzle, and FIG. 14(c) depicts a state where the area of the opening is smaller than in FIG. 14(b).

### DESCRIPTION OF EMBODIMENTS

FIG. 1 depicts a power generating apparatus (or “power generating unit”) 30 including an engine 10, which is equipped with a plurality of combustion units 80 and a gas turbine unit 39, and a generator 31, which is rotationally driven by the engine 10 via a shaft 38. The gas turbine unit 39 includes a radial turbine (or “radial flow turbine”) 39a on an upstream side and an axial flow turbine 39b on a downstream side. The four combustion units 80 are disposed at symmetrical positions around the radial turbine 39a. The number of combustion units 80 is not limited to four and may be five or more, and the combustion units 80 are not limited to being disposed at a pitch of 90 degrees. Each of the plurality of combustion units 80 is connected to the gas turbine unit 39 by a nozzle 15, and the gas turbine unit 39 is driven by combustion gas 51 supplied from the combustion units 80. The gas turbine unit 39 may be configured by the radial turbine 39a alone, or by the axial flow turbine 39b alone.

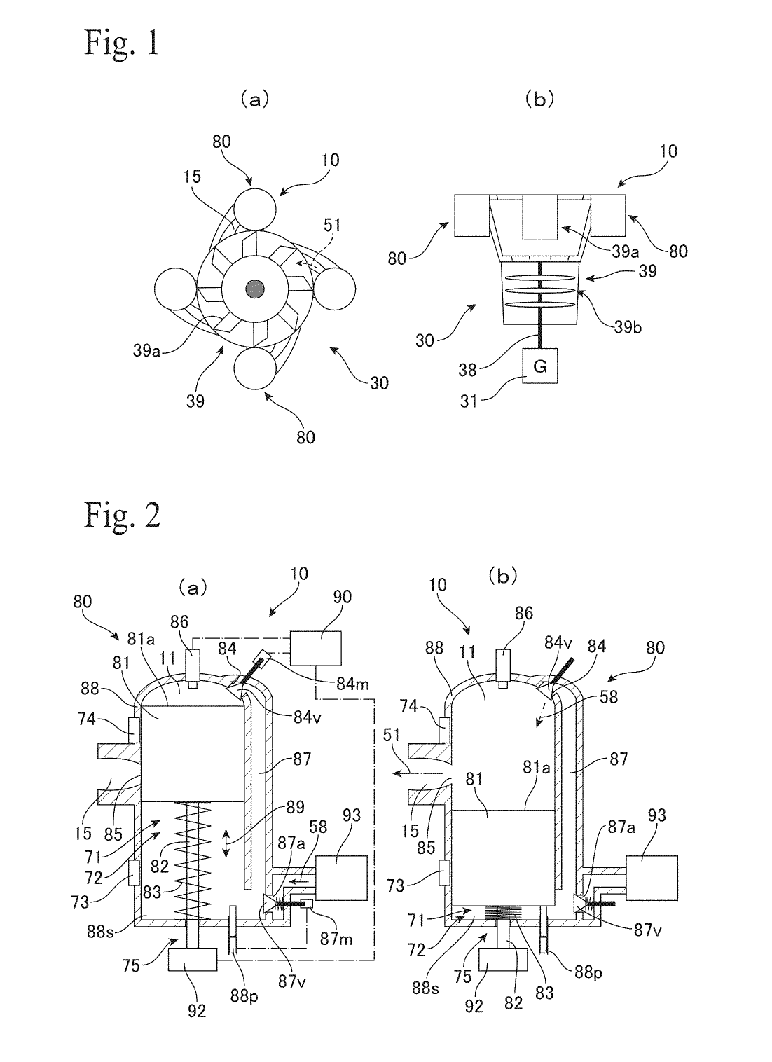

FIGS. 2(a) and (b) are simplified cross-sectional views depicting the structure of one combustion unit 80 that has been extracted. FIG. 2(a) depicts a state where a piston 81 has moved to an upper position, and FIG. 2(b) depicts a state where the piston 81 has moved to a lower position. Each combustion unit 80 includes a cylinder (or “cylinder frame”) 88 including a cylindrical combustion chamber 11, the piston 81 that moves in the longitudinal direction 89 inside the combustion chamber 11, a rod 82 that is connected to the piston 81, and a spring 83 disposed so as to move the piston 81 in the longitudinal direction 89 along the rod 82. In the combustion chamber 11, the longitudinal direction 89 may extend in the left-right (horizontal) direction instead of the vertical direction, but in the following description, an example where the longitudinal direction 89 is the up-down direction will be described.

In the present embodiment, the spring 83 is a coil spring, the rod 82 passes through the center of the spring 83, and the spring 83 lengthens and shortens around the rod 82. The spring 83 moves a surface (or “first wall surface”) 81a on the combustion chamber 11-side of the piston 81 that constructs or configures a part of the combustion chamber 11 using the elastic force of the spring 83, and acts as a first mechanism (or “first unit”) 71 that reduces the volume of the combustion chamber 11 to pressurize the gas inside the chamber 11. In the present embodiment, the spring 83 is a compression coil spring, but may be a cylindrical coil spring or a conical coil spring.

The combustion unit 80 further includes an intake port 84 provided in the upper part of the combustion chamber 11 for supplying the gas 58 into the combustion chamber 11, an intake valve (or “intake port valve”) 84v that opens and closes the intake port 84, a fuel injection apparatus 86 that injects fuel after the air supplied from the intake port 84 has been compressed by the first mechanism 71 and causes combustion of the fuel in the combustion chamber 11 to form combustion gas 51, and an exhaust port (or “ejection port”) 85 provided to discharge (eject) the combustion gas 51. The exhaust port 85 is provided on a wall surface of the combustion chamber 11 on a movement path of the piston 81 equipped with the first wall surface 81a, so that when the piston 81 has moved downward and the first wall surface 81a passes the exhaust port 85, the exhaust port 85 becomes connected to the combustion chamber 11 and the combustion gas (combustion product gas) 51 formed in the combustion chamber 11 is discharged (ejected) from the exhaust port 85 through the nozzle 15 to the turbine 39. Accordingly, in the combustion unit 80, the first mechanism 71 for moving the first wall surface 81a also serves as a second mechanism (or “second unit”) 72 that opens and closes the exhaust port 85 to control the timing at which the combustion gas 51 is discharged from the exhaust port 85.

The combustion unit 80 further includes a third mechanism (or “first stopper”) 73 that holds the position of the piston 81 with the first wall surface 81a at a lower position in the combustion chamber 11 against the elastic force of the spring 83 and a fourth mechanism (second stopper) 74 that holds the position of the piston 81 with the first wall surface 81a at an upper position in the combustion chamber 11 against the pressure inside the combustion chamber 11. The fourth mechanism (or “second stopper”) 74 may also have a further function of determining the position of the piston 81 at an upper position in the combustion chamber 11 against (to resist) the elastic force that drives the piston 81 upward. The stoppers 73 and 74 may mechanically engage the piston 81 directly to temporarily fix the position of the piston 81, or may temporarily fix the position of the piston 81 using an indirect force, such as magnetism.

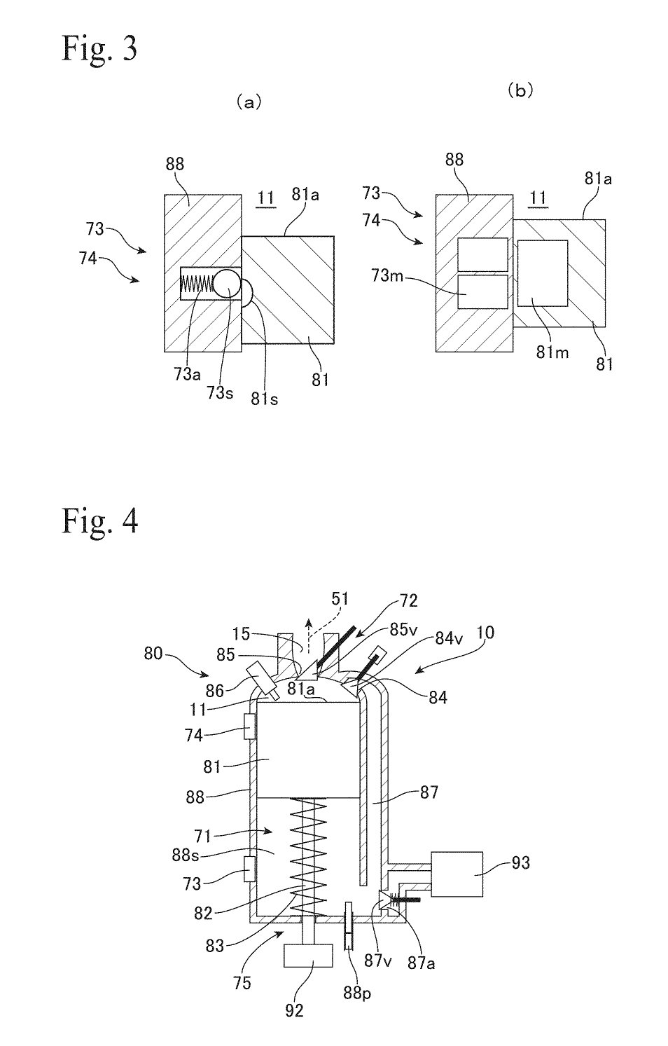

FIG. 3(a) depicts one example configuration of the first stopper 73 and the second stopper 74, which includes an engagement member 73s supported by a repelling member 73a, such as a spring, at a predetermined position on the cylinder frame 88. The engagement member 73s fits into a receiver portion 81s provided on the piston 81 and provides resistance for temporarily stopping the movement of the piston 81. FIG. 3 (b) depicts another example, which includes a magnet 73m embedded or attached at a predetermined position on the cylinder frame 88 and a magnet 81m embedded in or attached to the piston 81. The magnetic force of the magnets 73m and 81m provides resistance for temporarily stopping the movement of the piston 81. The first stopper 73 and the second stopper 74 for temporarily fixing the position of the piston 81 using either of the above methods or another method can select whether to temporarily fix the position of the piston 81 through use of an electric actuator, an electromagnet, or the like, and it is also possible to freely control the time for which the piston 81 is temporarily fixed at that position.

The combustion unit 80 further includes a fifth mechanism 75 that uses the rod 82 to move the piston 81 with the first wall surface 81a downward, that is, in a direction that expands the volume of the combustion chamber 11, against the elastic force of the spring 83. The combustion unit 80 includes an electrically-powered starter unit 92 with an electric actuator, for example, a motor, for driving the fifth mechanism 75 and a power transmission mechanism, such as an appropriate gear train. The starter unit 92 may be provided to independently move the rods 82 of the individual combustion units 80 or may be a common component provided to move the rods 82 of a plurality of combustion units 80 in concert. A starter unit 92 provided so as to independently move the rods 82 of the individual combustion units 80 can independently control the positions of the pistons 81 of the respective combustion units 80, which makes it easy to control the combustion state in the combustion chambers 11, for example, the ignition conditions, more optimally. The starter unit 92 includes a mechanism for recovering or regenerating energy using the built-in motor as a generator when combustion is repeatedly occurring in the combustion chamber 11 of the combustion unit 80 and the piston 81 is moving up and down due to the pressure of the combustion gas 51 and the elastic force of the spring 83.

The combustion unit 80 further includes, in the cylinder frame 88, a supply passage 87 provided so as to cover at least a part of the combustion chamber 11, a supply port 87a for supplying compressed gas, typically compressed air 58, from a compressor 93 to the supply passage 87, and a supply valve 87v for opening and closing the supply port 87a. The compressor 93 may be commonly provided for the plurality of combustion units 80, as one example is connected to the gas turbine unit 39, and may be a turbocharger that is driven by the exhaust of the gas turbine unit 39. The supply passage 87 is connected to the part of the cylinder frame 88 below the piston 81, that is, a space (or “primary storage chamber”) 88s in which the rod 82 and the spring 83 are disposed, so that the compressed air 58 introduced from the supply port 87a enters the primary storage chamber 88s. The primary storage chamber 88s is a region on the opposite side of the piston 81 to the combustion chamber 11, and the supply passage 87 has a function as a gas supplying system that temporarily stores the compressed air 58 in the primary storage chamber 88s on the opposite side of the piston 81 before the compressed air 58 is supplied to the combustion chamber 11.

By storing the compressed air 58 in the primary storage chamber 88s, the stored compressed air 58 is further compressed when the piston 81 moves downward due to combustion in the combustion chamber 11, so that the compressed air 58 acts together with the spring 83 as a damper for absorbing sudden movements of the piston 81. The primary storage chamber 88s includes a position sensor (a contact sensor, an optical sensor, or the like) 88p for detecting the position of the piston 81. When the piston 81 moves upward to compress the compressed air 58 inside the combustion chamber 11, it is also possible to open the supply valve 87v to further introduce the compressed air 58 into the primary storage chamber 88s, which makes it possible to make the pressure in the combustion chamber 11 and the pressure in the primary storage chamber 88s on both sides of the piston 81 as close as possible, thereby reducing the pressure difference and balancing the pressures. That is, if there were no elastic force of the spring 83, it would be possible to move the piston 81 in floating-like conditions between the combustion chamber 11 and the primary storage chamber 88s. By doing so, it is easy to move the piston 81 upward using the elastic force of the spring 83, which makes it possible to further compress the combustion air 58 in the combustion chamber 11 with a small elastic force. As one example, combustion air 58 that has been adiabatically compressed to close to the ignition temperature by the compressor 93 without actually reaching the ignition temperature is supplied to the combustion chamber 11 via the primary storage chamber 88s and is then adiabatically compressed by the piston 81 to raise the temperature of the combustion air 58 to the ignition temperature.

A metal spring 83 is preferable as the elastic body for providing the elastic force as the first mechanism 71 that drives the piston 81 under the above conditions. Other types of elastic bodies, for example rubber, may be used so long as they satisfy various conditions, such as the amount of movement of the piston 81, the elastic force (pressure) for causing movement, and temperature. A damper with viscoelasticity or a combination of a damper and a spring may be used.

The combustion unit 80 further includes a control unit (or “controller”) 90 for controlling an actuator 84w of the intake valve 84v, an actuator 87w of the supply valve 87v, the fuel injection apparatus (or “injection apparatus”) 86, the starter unit 92, and the like. The controller 90 may have a function of actively controlling the position of the piston 81 using the first stopper 73 and the second stopper 74, and may have a function of monitoring the position of the piston 81 using the position sensor 88p. By providing the stoppers 73 and 74 that control the position of the piston 81 in each combustion unit 80, the movement, stopping position, and stopped time of the piston 81 can be independently changed in units of combustion units 80, or in units of combustion chamber 11 individually and flexibly.

The first stopper 73 has a function of regulating the maximum volume of the combustion chamber 11 by controlling the lower position of the piston 81, that is, the position of the first wall surface 81a. The second stopper 74 has a function of regulating the minimum capacity of the combustion chamber 11 by regulating the upper position of the piston 81, that is, the position of the first wall surface 81a. A plurality of these first stoppers 73 and second stoppers 74 may be provided, and a mechanism for moving the positions of the first stopper(s) 73 and the second stopper(s) 74 in the combustion chamber 11 may be provided. By flexibly controlling the upper and/or lower positions where the position of the piston 81 is temporarily fixed against (to resist) the elastic force and/or the combustion pressure, it is possible to flexibly control the volume of the combustion chamber 11 and the stroke of the piston 81 independently in units (in each) of the individual combustion units 80 and even in units (in each) of intermittent occurrences of combustion.

As depicted in FIG. 2 (a), in the combustion unit 80, the piston 81 moves upward in the combustion chamber 11 due to the first mechanism 71 that uses the elastic force of the spring 83 to further compress (adiabatically compress) the compressed air 58 supplied to the combustion chamber 11. During the process of adiabatic compression, the intake valve 84v is closed. In this adiabatic compression process, if it is possible to achieve a sufficiently high compression ratio and increase the temperature of the compressed air 58 inside the combustion chamber 11 to the ignition temperature of the fuel, it will be possible to start combustion in the combustion chamber 11 by injecting fuel from the fuel injection apparatus 86 (like a compression ignition engine). If it is difficult in the process of adiabatic compression to raise the compression ratio of the compressed air 58 sufficiently to reach the ignition temperature, it is possible to start combustion in the combustion chamber 11 by supplying a fuel-air mix to the combustion chamber 11 in place of the compressed air 58 and providing an ignition device in place of the fuel injection apparatus 86 (like a spark ignition engine).

In either case, when burning fuel in the combustion chamber 11, an intermittent combustion cycle is produced where combustion (fire) intermittently occurs inside the combustion chamber 11. Theoretically, a diesel engine cycle in which combustion occurs at a constant pressure, an Otto cycle in which combustion occurs with a constant volume, or a state known as a “Sabathe cycle” having both features are realized. In the intermittent combustion cycle, it is possible to increase the pressure in the combustion chamber 11 during combustion using the produced combustion gas 51 itself, or a simple mechanism such as the piston 81, which makes it easy to obtain combustion gas 51 at a high temperature and high pressure.

In the combustion unit 80, combustion starts in the combustion chamber 11, the pressure in the combustion chamber 11 rises, and when the force acting upon the piston 81 becomes stronger than the elastic force of the spring 83 and the piston 81 is also released by the second stopper 74, the piston 81 moves downward due to the internal pressure in the combustion chamber 11. The timing at which the piston 81 starts to move downward in the cylinder 88, that is, in the direction in which the volume of the combustion chamber 11 expands can be adjusted by adjusting the elastic force (spring constant) of the spring 83, the force with which the second stopper 74 holds the piston 81, as examples, adjusting the elastic force of the spring 73a or the magnetic force of the magnet 73m, and providing the second stopper 74 with a mechanical lock. When an electromagnet is used, it is possible for the controller 90 to release the electromagnet to control the timing at which the piston 81 is actively released.

In the combustion unit 80, when the piston 81 is released from the second stopper (or “fourth mechanism”) 74, the piston 81 moves downward due to the internal pressure (combustion pressure) of the combustion chamber 11, the combustion gas 51 expands, and at the same time, the exhaust port 85 provided on a movement path of the piston 81 opens, so that the combustion gas 51 produced in the combustion chamber 11 further expands and is supplied to the turbine unit (or “turbine”) 39 via the nozzle 15. Therefore, the timing at which the piston 81 is released is the timing at which the exhaust port 85 is opened. The timing at which the exhaust port 85 is opened and the combustion gas 51 is supplied to the turbine 39 may be any timing where it is possible to drive the turbine 39 most efficiently with the combustion gas 51 produced in the combustion chamber 11, and may be during an intermittent combustion after combustion has started in the combustion chamber 11 or may be after the combustion has ended.

Typical timing is to release and move the piston 81 and open the exhaust port 85 while combustion (firing) continues in the combustion chamber 11. By opening the exhaust port 85 with this timing, combustion (firing) can transition from constant-volume combustion to constant-pressure combustion, which makes it possible to extend the combustion time relative to explosive combustion and extend the time for which the combustion gas 51 is supplied. After the combustion has ended, the combustion product gas 51 adiabatically expands and is supplied from the combustion chamber 11 to the turbine 39. In addition, spark ignition or compression ignition where self-ignition is caused by compressing air or a fuel-air mix may be used. Compression ignition can extend the combustion time, and may be one example of how the time for which the combustion gas 51 can be continuously supplied to the turbine 39 may be extended. As one example, a gasoline engine that uses HCCI (Homogeneous Charge Compression Ignition) has been developed in recent years, and it is possible to apply such combustion technology to this combustion unit 80. Although intermittent combustion is repeated in the combustion unit 80 by opening the exhaust port 85 during combustion, this makes it possible to supply combustion gas (exhaust gas) 51 with a high temperature and high pressure to the turbine 39 more continuously.

The combustion unit 80 is equipped with the first stopper (or “third mechanism”) 73 so that it is possible to temporarily fix the piston 81 against the elastic force of the spring 83 in a state in which the position of the piston 81 has moved downward. Accordingly, it is possible to fix the piston 81 and hold the exhaust port 85 open until a state where the internal pressure of the combustion chamber 11 is lower than the pressure applied to the piston 81 by the spring 83 is reached, which makes it possible to supply the combustion gas 51 to the turbine 39 for a longer period. Also, in this state, it is possible to open the intake valve 84v so that the combustion air 58 that was stored in the primary storage chamber 88s can be supplied to the combustion chamber 11 via the intake port 84 and the supply passage 87, which purges the combustion chamber 11 and makes it possible to replace the combustion chamber 11 with combustion air 58. It is possible to supply a mixed gas, which is a mix of fuel and air, to the combustion chamber 11 from the intake port 84 to replace the combustion air 58.

As depicted in FIG. 2(a), when the piston 81 is located in the upper part of the combustion chamber 11, the combustion air 58 is supplied to the primary storage chamber 88s via the supply port 87a and held in the primary storage chamber 88s. As depicted in FIG. 2(a), after this, by moving the piston 81 downward, the combustion air 58 inside the primary storage chamber 88s is further compressed, and when the intake port 84 is opened, the combustion air 58 is ejected into the combustion chamber 11. After this, by releasing the piston 81 from the first stopper 73, the piston 81 moves upward due to the elastic force of the spring 83. Due to the piston 81 moving upward, the exhaust port 85 closes, and by closing the intake port 84 using the intake valve 84v, the combustion air 58 that has been supplied into the combustion chamber 11 is adiabatically compressed. The timing at which the piston 81 is released by the first stopper 73 can be controlled or adjusted by the same methods as the second stopper 74 described earlier.

In the combustion unit 80, the piston 81 moves downward due to the pressure of the combustion gas 51, and by then moving the piston 81 upward using the elastic force of the spring 83 that is shortened (deformed) when the piston 81 moves downward, the air or the mixed gas is compressed. At the start of the combustion unit 80, the piston 81 is moved downward (in the direction in which the volume of the combustion chamber 11 increases) by the starter unit 92 via the rod 82 to forcibly deform the spring 83 and make it possible to use the elastic force of the spring 83 at the next step. In the combustion unit 80, once a state is reached where the piston 81 is continuously (intermittently) moving up and down due to the elastic force of the spring 83 and the pressure of the combustion gas 51 and combustion is repeated, the starter 92 generates electricity from the up-down movement of the piston 81, which makes it possible to recover or regenerate the energy that moves the piston 81 up and down as electric power.

In this way, in the combustion unit 80, the piston 81 is moved using the elastic force of the spring 83 which makes it possible to increase the compression ratio of the air or the mixed gas in the combustion chamber 11 with a simple configuration and produce the combustion gas 51 in the combustion chamber 11 due to self-ignition, spark ignition, or the like. The timing at which the piston 81 moves upward or downward can be controlled by the first and second stoppers 73 and 74, and by adjusting the timing at which the exhaust port 85 is opened and closed, it is possible to control the state in which the combustion gas 51 produced by the intermittent combustion is supplied to the turbine 39.

In addition, in the combustion unit 80, the piston 81 is moved with a constant load that is sufficiently large to resist the elastic force of the spring 83 that drives the first mechanism 71, which makes it possible to repeat combustion in a short period composed of two cycles and supply combustion gas 51 to the turbine 39. This means that it is possible to arrange a plurality of combustion units 80 with a simple configuration with respect to the turbine 39 and to supply the combustion gas 51 to the turbine 39 from the combustion units 80 with a short cycle at different timing from the plurality of combustion units 80 or with synchronized timing with the combustion units 80 divided into several groups. Accordingly, with the engine 10, on the combustion side, as the intermittent combustion, it is possible to raise the combustion temperature in the same way as the Otto cycle, the diesel cycle, or the Sabathe cycle, and possible to supply the combustion gas 51 pseudo-continuously with a short cycle from the plurality of combustion units 80 to a gas turbine unit 39 that is usually explained using the Brayton cycle that has continuous combustion, which makes it possible to drive the gas turbine unit 39 with high efficiency.

The speed (period) of the combustion cycle in each combustion unit 80 can be controlled by changing the amount of fuel (mixing ratio) to be supplied to the combustion chamber 11, by changing the ignition timing in the combustion chamber 11, by providing an appliance, such as a relief valve, that controls the pressure inside the combustion chamber 11, and by changing the elastic force by a method such as controlling the length of the spring 83 that moves the piston 81. It is also possible to change the states described above at the start and during normal operation of the combustion units 80. Also, in the combustion unit 80, since it is possible to flexibly control movement of the piston 81 and the combustion state in the combustion chamber 11, it is possible to use various substances, such as light oil, gasoline, alcohol, and hydrogen, as the fuel.

FIG. 4 depicts a different example of the combustion unit 80. This combustion unit 80 is provided with an exhaust port 85 that ejects the combustion gas 51 in an upper part of the combustion chamber 11, and includes an exhaust valve 85v for opening and closing the exhaust port 85. Accordingly, by controlling the exhaust valve 85v with the controller 90, it is possible to control the timing at which the combustion gas 51 is discharged from the combustion chamber 11, with the exhaust valve 85v functioning as the second mechanism 72. The rest of the configuration is the same as the combustion unit 80 described above. In this combustion unit 80, it is possible to open and close the exhaust port 85 without this being related to the movement of the piston 81. Accordingly, the combustion gas 51 can be supplied to the turbine 39 by opening the exhaust port 85 in a state where the piston 81 has been temporarily fixed in the upper part of the combustion chamber 11 by the second stopper 74. It is also possible to open the exhaust port 85 and supply the combustion gas 51 to the turbine 39 while the piston 81 is moving, and possible to control the state of the combustion gas 51 supplied to the turbine 39 more flexibly.

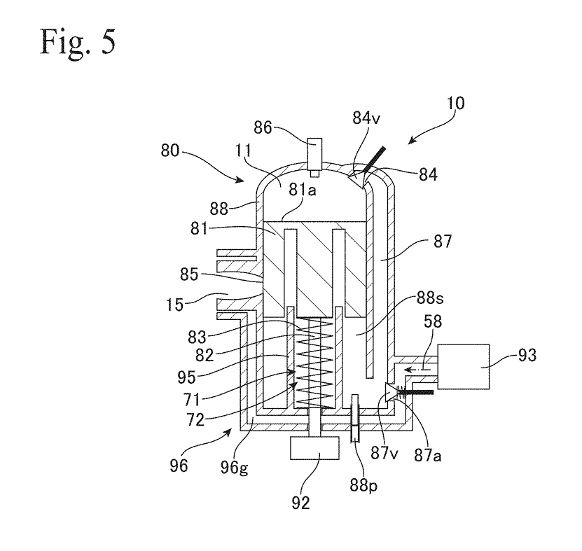

FIG. 5 depicts yet another example of the combustion unit 80. This combustion unit 80 includes a guide 95 for stabilizing the up-down movement of the piston 81 and a cooling mechanism 96 for the cylinder frame 88. The cooling mechanism 96 cools the combustion unit 80 by having part of the compressed air 58 supplied from the compressor 93 flow in a double-walled structure (or “jacket”) 96g provided outside the cylinder frame 88 so as to surround the cylinder frame 88, including the nozzle 15.

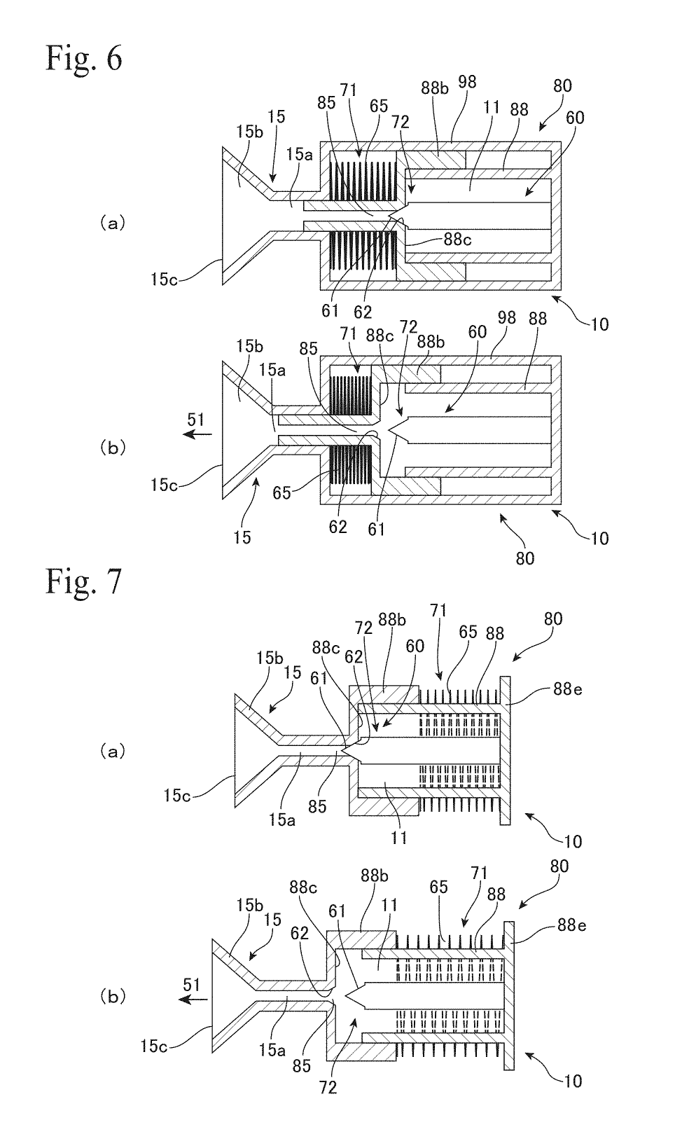

FIGS. 6(a) and 6(b) depict yet another example of the combustion unit 80. This combustion unit 80 includes the combustion chamber 11, a critical nozzle 15 connected to the exhaust port 85 of the combustion chamber 11, and a back pressure control unit 60 for controlling the pressure of the combustion gas 51 supplied from the combustion chamber 11 to the critical nozzle 15. The back pressure control unit 60 is a needle-valve type and includes a valve head (or “first part”) 61 that is conical or shaped as a truncated cone, with the valve head 61 contacting a funnel-shaped part (or “second part”) 62 of the exhaust port 85 to choke the flow of the combustion gas 51 to the nozzle 15. The back pressure control unit 60 therefore functions as the second mechanism 72 that controls the timing at which the combustion gas 51 is ejected from the exhaust port 85.

In this combustion unit 80, the cylinder frame 88 that constructs the combustion chamber 11 is housed inside a case 98, and due to the internal pressure during combustion (explosions) in the combustion chamber 11, a part (front part) 88b of the cylinder frame 88 including the exhaust port 85 moves inside the case 98 against the elastic force of a spring 65. Accordingly, a wall surface 88c of the front part 88b of the cylinder frame 88 that faces the combustion chamber 11 acts as the first wall surface, and as depicted in FIG. 6(a), moves due to the elastic force of the spring 65 in a direction in which the volume of the combustion chamber 11 is reduced to compress the combustion air or the mixed gas supplied to the combustion chamber 11. Accordingly, the spring 65 functions as the first mechanism 71. Note that although this combustion unit 80 may include a mechanism for supplying combustion air or a mixed gas to the combustion chamber 11 and a mechanism for injecting and/or igniting fuel inside the combustion chamber 11 in the same way as the combustion unit 80 described above, such mechanisms are omitted from the drawings.

When the combustion gas 51 is produced inside the combustion chamber 11, due to the pressure of the combustion gas 51, the front part 88b moves instead of the piston 81 of the combustion units 80 described above and opens the exhaust port 85 so that the combustion gas 51 is supplied to the turbine 39. The first mechanism 71 that controls the amount of movement of the front part 88b may be the spring 65 or may be an appropriate mechanical mechanism, such as a hydraulic damper.

One example of the nozzle 15 that supplies the combustion gas 51 from the combustion chamber 11 to the turbine 39 is a critical nozzle (or “supersonic nozzle” or “de Laval nozzle”). This critical nozzle 15 includes a throat portion 15a with a narrowed cross-sectional area so as to initially choke the flow, a diffuse (or “diffuser”) 15b where the pipe expands, and a nozzle outlet 15c. To achieve a supersonic speed for the combustion gas 51 outputted from the nozzle outlet 15c of the critical nozzle 15, it is necessary for the flow velocity at the throat portion 15a to be the speed of sound (i.e., Mach 1). For the flow velocity at the throat portion 15a to reach the speed of sound, it is necessary for the back pressure (the pressure of the incoming combustion product gas 51) Pb at the throat portion 15a to be at least equal to a critical back pressure ratio Rc with respect to the pressure at the nozzle outlet 15c.

If the back pressure Pb is equal to or lower than the critical back pressure ratio Rc, the flow velocity does not accelerate at the diffuser 15b of the critical nozzle 15 and conversely decelerates, reducing the contribution of the combustion gas 51 to the turbine 39 so that the nozzle 15 can potentially cause an energy loss. In addition, there is the possibility of the pressure at the turbine 39 propagating to the combustion chamber 11, which can have an adverse effect on the combustion in the combustion chamber 11.

The second mechanism 72 that opens and closes the exhaust port 85 in the combustion unit 80 may have a function as the back pressure control unit 60 that controls the timing at which the exhaust port 85 is opened so as to control the pressure inside the combustion chamber 11 after the start of combustion to be within a predetermined range that is equal to or higher than the critical pressure ratio (or “critical back pressure ratio”) Rc. The back pressure control unit 60 ensures that the flow velocity at the throat portion 15a of the critical nozzle 15 is the speed of sound, so that supersonic combustion gas 51 is supplied from the critical nozzle 15 to the turbine 39.

When the combustion gas 51 is supplied to the nozzle 15, the internal pressure (back pressure) Pb of the combustion chamber 11 gradually decreases from the initial state after combustion. For this reason, the critical nozzle 15 is designed for the back pressure Pb after the pressure reduction, and when this falls below the critical pressure ratio Rc, supersonic combustion gas 51 cannot be obtained. The internal pressure of the combustion chamber 11 is also low while the fuel gas is being supplied to the combustion chamber 11 and immediately after ignition. For this reason, the second mechanism 72 that also serves as the back pressure control unit 60 closes the exhaust port 85 until the combustion chamber 11 reaches a predetermined pressure.

FIGS. 7(a) and 7(b) depict yet another example of the combustion unit 80. In this combustion unit 80, the front part 88b of the cylinder frame 88 including the exhaust port 85 is attached to the rear end 88e of the cylinder frame 88 by a spring 65 and moves against the elastic force of the spring 65 due to the internal pressure in the combustion chamber 11 during combustion. Accordingly, the wall surface 88c of the front portion 88b of the cylinder frame 88 that faces the combustion chamber 11 acts as the first wall surface, and the spring 65 functions as the first mechanism 71. The spring 65 in the present embodiment is not a compression spring and instead is a tension-type coil spring that moves the first wall surface 88c in a direction in which the volume of the combustion chamber 11 decreases using a tensile elastic force (pulling elastic force).

As depicted in FIG. 7 (a), the wall surface 88c moves due to the elastic force of the spring 65 in a direction where the volume of the combustion chamber 11 decreases and compresses the combustion air or mixed gas supplied to the combustion chamber 11. When the combustion gas 51 is produced in the combustion chamber 11, the front part 88b of the cylinder frame moves due to the pressure of the combustion gas 51 as depicted in FIG. 7(b) to open the exhaust port 85, so that the combustion gas 51 is supplied to the turbine 39. A needle-type back pressure control unit 60 for opening and closing the exhaust port 85 is provided in the combustion chamber 11 and functions as the second mechanism 72 that controls the timing at which the combustion gas 51 is ejected from the exhaust port 85. Note that although the combustion unit 80 may also include a mechanism for supplying combustion air or mixed gas to the combustion chamber 11 and a mechanism for injecting and/or igniting fuel inside the combustion chamber 11 in the same way as the combustion unit 80 described above, such mechanisms are omitted from the drawings.

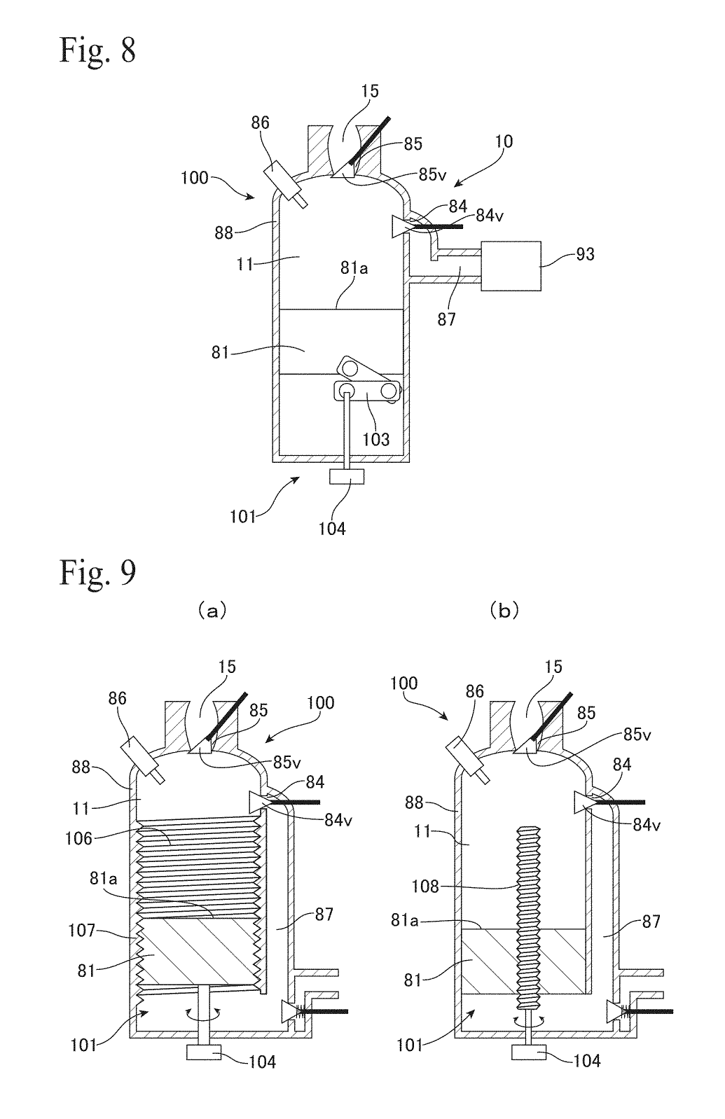

FIG. 8 depicts yet another example of a combustion unit. The combustion unit 100 includes a drive mechanism 101 that moves the piston 81 up and down using an external driving source. The combustion unit 100 depicted in FIG. 8 is one example where the drive mechanism 101 includes a crank 103 in which two rod-shaped members are rotatably coupled, and a motor 104 that flexibly controls the position of the piston 81 in the up-down direction by rotating one end of the crank 103 to lengthen and shorten the crank 103 in the up-down direction. In this combustion unit 100, an external driving source, such as the motor 104, is always required to move the piston 81 up and down and change the volume of the combustion chamber 11. Accordingly, electric power to drive the external driving source is always necessary. On the other hand, it is easy to control the position of the piston 81 individually in units of combustion units 100 by using the drive mechanism 101 to fix the rotation angle of the crank 103 at predetermined angles, such as 90 degrees and 180 degrees. It is also possible to change the stroke of the piston 81 by changing the direction of rotation of the crank 103 and/or reversing the crank 103. By providing the mechanism 101 for driving the piston 81 in units of the combustion units 100, it is possible to precisely and flexibly control operations (operating conditions) such as the stopping position, the stopped time, and the movement speed of the piston 81 independently in units of the combustion unit 100. Every time combustion occurs in the combustion chamber 11, control may be performed to move the piston 81 up and down to compress the combustion air or mixed gas, or to fix the position of the piston 81 to fix the volume of the combustion chamber 11 so that constant volume combustion is carried out inside the combustion chamber 11.

FIG. 9 depicts yet another example of the combustion unit 100. The driving mechanism 101 of the combustion unit 100 depicted in FIG. 9(a) is a type where the piston 81 is rotated by the motor 104. A thread (female thread) 106 is provided on the inner peripheral surface of the cylinder frame 88, and a corresponding thread (male thread) 107 is provided on the outer circumferential surface of the piston 81. Accordingly, by rotating the piston 81 in a predetermined direction or reversing the piston, the movement of the piston 81 inside the combustion chamber 11, including the stopping position, the stopped time, the movement speed, and the stroke can be individually and freely controlled, which makes it possible to make adjustments so as to start combustion at conditions that are optimal for combustion and/or to supply combustion gas 51 with optimal conditions to the turbine 39.

The drive mechanism 101 of the combustion unit 100 depicted in FIG. 9(b) includes a threaded rod 108 which is rotated by the motor 104. By rotating the threaded rod 108, the piston 81 is moved in the up-down direction along the threaded rod 108. Accordingly, by rotating the threaded rod 108 in a predetermined direction or reversing the threaded rod 108, it is possible to freely control the position of the piston 81 inside the combustion chamber 11.

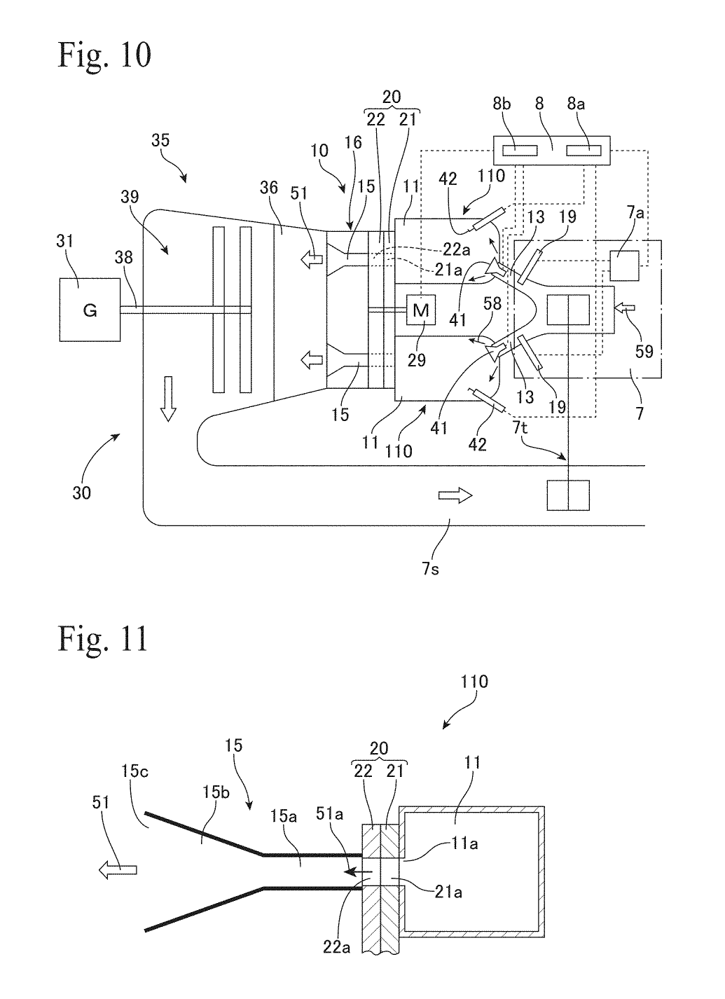

FIG. 10 depicts another example of a power generating apparatus 30 equipped with a different engine 10. The power generating apparatus 30 is an example of a pulse combustion power generating apparatus including a pulse combustion-type engine (pulse combustion apparatus) 10 and a generator 31 that is rotationally driven by the engine 10. The engine 10 includes a plurality of combustion units 110 each equipped with a constant volume combustion chamber 11. The power generating unit 30 further includes a fuel supplying system 7 for supplying mixed air for combustion, which contains fuel and combustion air, to the engine 10, and a control system 8 for controlling the engine 10, including the combustion timing. The control system 8 includes an ignition control unit 8a for controlling ignition timing of an igniter 42 as an ignition means, and an opening/closing control unit 8b for controlling valves and the like.

Each combustion unit 110 of the engine 10 is a type that outputs (ejects) the combustion gas 51 produced by combustion in the combustion chamber 11 as a main driving force (or “power source”). The engine 10 includes the combustion units 110 that are equipped with combustion chambers 11 of a constant volume, fuel supplying paths (intake ports) 13 for supplying gas (or “mixed gas”) 58, in which fuel and air as an oxidant have been mixed, from the fuel supplying system 7 to the combustion chambers 11, valves (opening/closing devices) 41 for opening and closing the fuel supplying paths 13, igniters 42 for igniting the mixed gas 58 in the combustion chambers 11, nozzle units 16 including nozzles that discharge the gas (or “combustion gas” or “high-pressure gas”) 51 produced in the combustion chambers 11, a back pressure control unit 20 that intermittently opens and closes paths between the nozzles 15 and the combustion chambers 11 to control the back pressure of the nozzles 15, an MHD power generating unit 36 that generates electricity from the combustion gas 51 discharged from the nozzles 15, a micro gas turbine unit (or “turbine”) 39 disposed downstream of the MHD power generating unit 36, and a generator 31 connected to the shaft 38 of the turbine 39. The power generating system 35 may have an MHD-micro gas turbine combined cycle, the cycle of a gas turbine alone, or a combined cycle where a fuel cell unit, a thermal generation unit, or the like is connected downstream of a gas turbine.

The fuel supplying system 7 for supplying the mixed gas 58 to the combustion chambers 11 includes an injection system 19, which injects the fuel into combustion air 59 that has been pressurized by a turbocharger 7t provided in an exhaust system 7s of the turbine 39, and a fuel injection control system 7a for controlling the injection timing. The fuel supplying system 7 may also be equipped with a compressor, a blower, a supercharger, or other independent air compressing unit that is driven by the turbine 39. The engine 10 may be further equipped with a purging system that purges the combustion gas 51 after the combustion gas 51 has been intermittently supplied to the nozzles 15 from the combustion chambers 11 by the back pressure control unit 20, and thereafter injects combustion air 59 into the combustion chambers 11 using the fuel supplying system 7. One example of a purging system is a valve that intermittently connects the combustion chambers 11 and the exhaust system 7s at appropriate timing in concert with operation of the back pressure control unit 20.

Although the engine 10 depicted in FIG. 10 includes two combustion units 110, the number of combustion units 110 may be one, or three or more. In order to continuously supply the combustion gas 51 to the turbine 39, as described earlier, it is preferable to provide a plurality of combustion units 110 that perform intermittent combustion. The combustion chamber 11 of each combustion unit 110 may be cylindrical, oval, or spherical, or may be any shape suitable for combustion and outputting of the combustion gas produced in the combustion chamber 11.

In the engine 10, the back pressure control unit 20, which intermittently opens and closes the paths between the nozzles 15 and the combustion chambers 11 to control the back pressure for the nozzles 15 and the timing of discharge of the combustion gas 51, includes two rotating plates (or “disks”) 21 and 22 and a driving device 29 that synchronously rotates the rotating plates 21 and 22. The rotating plates 21 and 22 respectively include openings 21a and 22a which move between the respective combustion chambers 11 and the nozzles 15 corresponding to the combustion chambers 11, and are synchronously driven by the driving device 29 so as to rotate in opposite directions. When the positions of the openings 21a and 22a of the respective rotating plates 21 and 22 match, a combustion chamber 11 and a nozzle 15 become connected through the openings 21a and 22a so that the combustion gas 51 is supplied from the combustion chamber 11 via the nozzle 15 to the power generating system 35. The driving device 29 is controlled by the control system 8 so that the combustion chambers 11 and the nozzles 15 become connected by the openings 21a and 22a and combustion gas 51 of a predetermined pressure is supplied to the nozzles 15 at timing when a predetermined time has passed from the ignition timing and the internal pressure of the combustion chamber 11 has reached a predetermined pressure due to combustion.

FIG. 11 depicts a combustion unit 110 that is equipped with a nozzle 15, a combustion chamber 11, and a back pressure control unit 20 and has been extracted. The back pressure control unit 20 includes the two disc-shaped opening/closing panels (rotating plates) 21 and 22, with the openings 21a and 22a of the rotating plates 21 and 22 opening and closing the opening (exhaust port) 11a of the combustion chamber 11 and controlling the intake of the combustion gas 51a from the combustion chamber 11 into the nozzle 15.

An example of the nozzle 15 is the critical nozzle (or “supersonic nozzle” or “de Laval nozzle”) described above, and includes the throat portion 15a with a narrowed cross-sectional area so as to initially choke the flow, a diffuse (or “diffuser”) 15b where the pipe expands, and a nozzle outlet 15c. In this engine 10, the back pressure control unit 20 is provided to control the speeds of the discs 21 and 22 that rotate in opposite directions, and while the pressure inside the combustion chamber 11 after the start of combustion is within a predetermined range that is equal to or higher than the critical pressure ratio Rc, the critical nozzle 15 is connected to the combustion chamber 11 through the openings 21a and 22a. By doing so, the flow velocity at the throat portion 15a of the critical nozzle 15 becomes the speed of sound, and supersonic combustion gas 51 is supplied to the power generating system 35 from the critical nozzle 15.

In the engine 10, the combustion chamber 11 is closed by the back pressure control unit 20 until a predetermined pressure is reached (generated), and remains opened until the pressure decreases to a predetermined pressure. Since the pressure in the combustion chamber 11 is controlled by the back pressure control unit 20, the mixed gas 58 can be injected into the combustion chamber 11 by the fuel supplying system 7 in a compressed state before combustion, which makes it possible to improve the compression ratio. In the combustion chamber 11, constant volume combustion is performed after ignition, which means that the cycle efficiency can be improved.

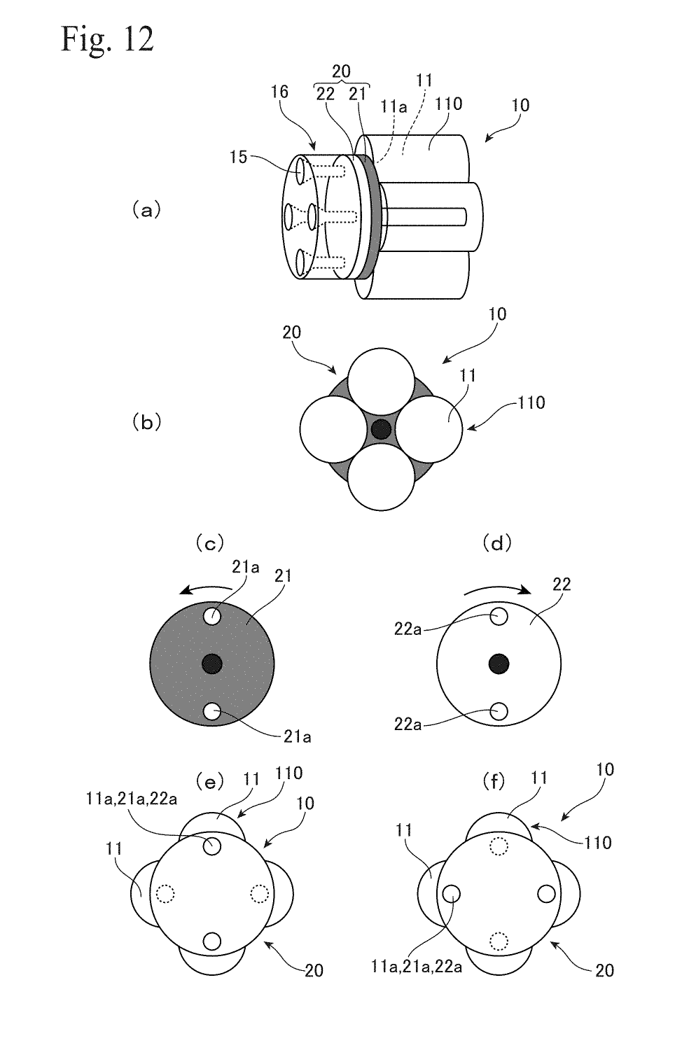

FIG. 12 depicts a different example of the engine 10. As depicted in FIGS. 12(a) and 12(b), in this engine 10, four combustion units 110 are disposed circumferentially, with the engine 10 also including a back pressure control unit 20 including two disc-shaped opening/closing panels 21 and 22, and a nozzle unit 16 including four critical nozzles 15 that correspond to the combustion chambers 11 of the four combustion units 110. As depicted in FIGS. 12(c) and 12(d), each of the opening/closing panels (the first disc and the second disc) 21 and 22 includes openings 21a and 22a at symmetrical positions 180 degrees apart, with the openings 21a and 22a passing in front of (i.e., on the injection side of) combustion chamber openings 11a provided in the centers of end walls of the combustion chambers 11. The opening/closing panels 21 and 22 that form two overlapping layers rotate in opposite directions. This means that as depicted in FIGS. 12(e) and 12(f), the pair of openings 11a of the combustion chambers 11 of the upper and lower, and left and right are opened at the pitch of 90 degrees by the back pressure control unit 20, so that the combustion gas 51a with a predetermined pressure is supplied from the openings 11a at the center of the combustion chambers 11 to the nozzles 15.

In addition, when the openings 21a and 22a provided in the opening/closing panels 21 and 22 are smaller than the openings 11a, the flow rate of the combustion gas 51a supplied to the nozzles 15 is controlled by the smaller of the openings 21a and 22a.

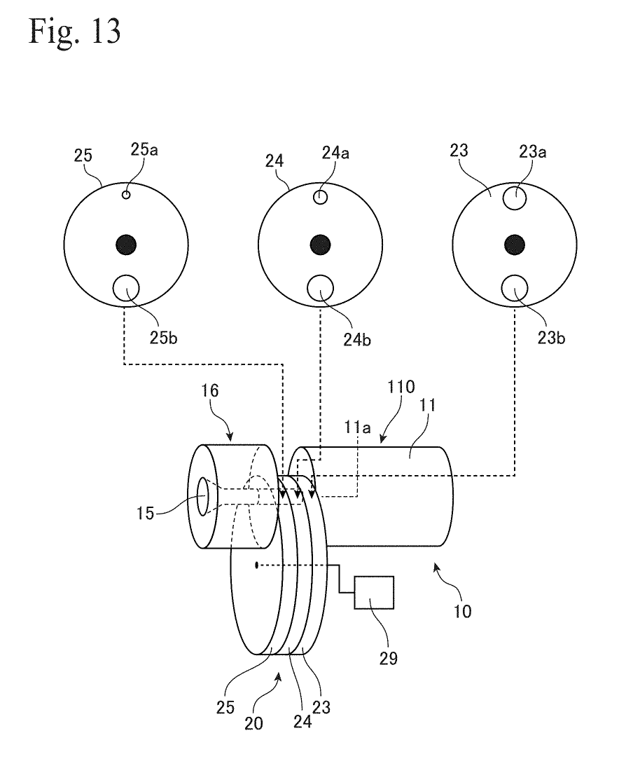

FIG. 13 depicts an example of a back pressure control unit 20 equipped with opening/closing panels 23, 24 and 25 that have openings of different sizes. The disc-shaped first opening/closing panel 23 includes first openings 23a and 23b with a first diameter d1. The second opening/closing panel 24 includes a second opening 24a with a diameter d2 that is smaller than the diameter d1 of the first opening 23a and an opening 24b with the same diameter d1 as the first opening 23a. The third opening/closing panel 25 includes a third opening 25a with a diameter d3 that is smaller than the diameter d2 of the second opening 24a and an opening 25b with the same diameter d1 as the first opening 23a.

In the back pressure control unit 20, by rotating the first opening/closing panel 23 in a state where the openings 24b and 25b of the second and third opening/closing panels 24 and 25 have been aligned at the position of the opening 11a of the combustion chamber 11, it is possible to connect the nozzle 15 and the combustion chamber 11 via a passage with the diameter d1 of the first opening 23a. By rotating the first opening/closing panel 23 in a state where the second opening 24a of the second opening/closing panel 24 and the opening 25b of the third opening/closing panel 25 have been aligned at the position of the opening 11a of the combustion chamber 11, it is possible to connect the nozzle 15 and the combustion chamber 11 via a passage with the diameter d2 of the second opening 24a. By rotating the first closing panel 23 in a state where the second opening 24a or the opening 24b of the second opening/closing panel 24 and the third opening 25a of the third opening/closing panel 25 have been aligned with the position of the opening 11a of the combustion chamber 11, it is possible to connect the nozzle 15 and the combustion chamber 11 via a passage with the diameter d3 of the third opening 25a.

In this way, by rotating the opening/closing panels (discs) 23, 24 and 25 equipped with the openings 23a, 24a and 25a that have different diameters to appropriate positions using the driving device 29, it is possible to supply the combustion gas 51a to the nozzle 15 via an opening (exhaust port) with one of the diameters d1, d2 and d3. By controlling the amount of gas passing through the throat 15a of the critical nozzle 15, it is possible to control the flow velocity and temperature of the combustion gas 51 supplied from the nozzle opening (nozzle outlet) 15c to the power generating system 35.

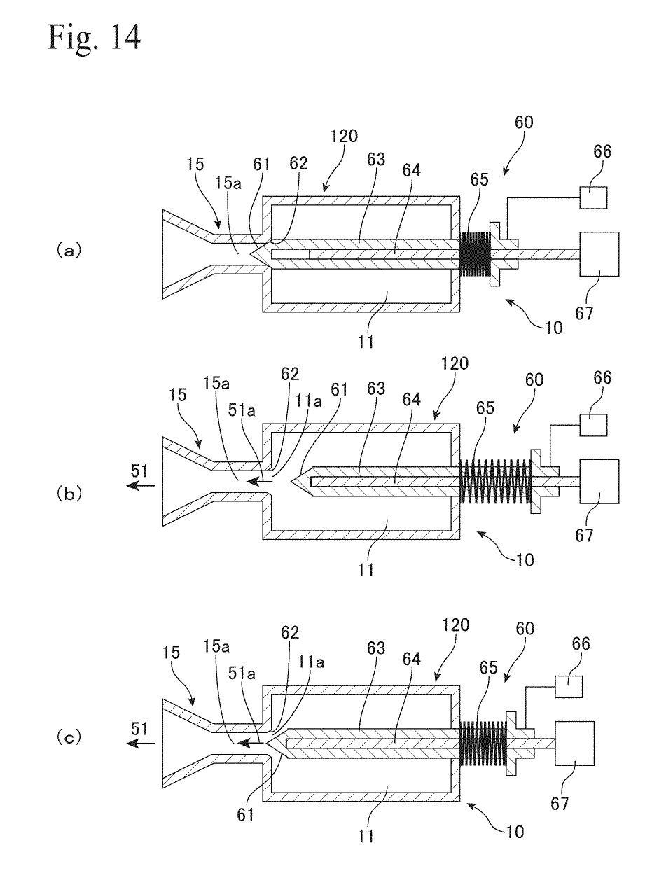

FIGS. 14(a) to 14(c) depict a different example of a combustion unit. The combustion unit 120 also includes a combustion chamber 11, a critical nozzle 15, and a back pressure control unit 60 that controls the pressure of the combustion gas supplied from the combustion chamber 11 to the critical nozzle 15. The back pressure control unit 60 of the present embodiment is a needle valve type, and includes a valve head (or “first part”) 61 shaped as a cone or a truncated cone, an opening portion (or “second part”) 62 that contacts the valve head 61 to close the flow of the combustion gas 51a to the nozzle 15, an opening/closing control unit 66 that controls movement of the valve head 61, and an opening degree control unit 67 that controls the distance when the valve head 61 and the opening portion 62 are separated (i.e., when the valve is open). The opening/closing control unit 66 releases a state where a valve shaft 63, the front tip of which is the valve head 61, is locked in a closed position, that is, the state where the valve head 61 is pressed against the opening portion 62, and moves the valve shaft 63 in a direction where the valve shaft 63 is pulled out from the chamber 11 using a spring 65. The internal opening degree control unit 67 is coaxially housed inside the valve shaft 63 and controls the protruding amount (length) of an opening degree adjusting rod 64 that also serves as a guide for the valve shaft 63 to limit the amount of movement of the valve shaft 63, that is, the valve head 61, that moves from the closed state to the open state.

Accordingly, when the valve head 61 moves from the closed state depicted in FIG. 14(a) to the opened state depicted in FIG. 14(b), movement of the valve head 61 is regulated by the rod 64, and the opening 11a is formed in a state where the distance between the valve head 61 and the opening 62 is controlled to produce a predetermined degree of opening (opening area). As depicted in FIG. 14(c), if the withdrawal distance of the rod 64 is small, the distance between the valve head 61 and the opening portion 62 will be small, which makes the degree of opening (opening area) of the opening 11a small.

As described above, it is possible to supply a pulse combustion apparatus including a combustion chamber that performs intermittent combustion, a critical nozzle connected to the combustion chamber, and a back pressure control unit that intermittently opens and closes a passage between the combustion chamber and the throat portion of the critical nozzle. By connecting the combustion chamber and the critical nozzle (or “supersonic nozzle” or “de Laval nozzle”) via the back pressure control unit, it is possible to control the pressure at which the combustion gas intermittently produced in the combustion chamber flows into the throat portion of the critical nozzle. In addition, since it is possible to start intermittent combustion in the combustion chamber in a state where the combustion chamber is separated from the critical nozzle by the back pressure control unit, it is easy to control the combustion in the combustion chamber. Accordingly, it is possible to provide a pulse combustion apparatus capable of realizing highly efficient and stable combustion in a constant-volume or almost constant-volume combustion state with high cycle efficiency and a compression ratio that is higher than a jet engine for example, and capable of outputting supersonic combustion gas.

The pulse combustion apparatus may have a plurality of combustion chambers arranged around the circumference and a plurality of critical nozzles connected to the respective chambers of the plurality of combustion chambers. The back pressure control unit includes a first disc and a second disc which revolve in opposite directions between the plurality of combustion chambers and the plurality of critical nozzles, and the first disc and the second disc may include at least one opening disposed between the combustion chambers and the critical nozzles. The timing at which a combustion chamber and a critical nozzle are connected by the first and second discs is controlled, and by doing so, the pressure of the combustion gas supplied to the throat portion can be controlled.

The back pressure control unit includes a first disc and a second disc which revolve between the plurality of combustion chambers and the plurality of critical nozzles, where the first disc may include at least first opening disposed between the combustion chamber and the critical nozzle and the second disc may include a plurality of openings arranged between the combustion chamber and the critical nozzle, including an opening that is the same as or larger than the first opening and a second opening that is smaller than the first opening. The pressure and the flow rate of the combustion gas flowing into the critical nozzle can be controlled by changing the size of the opening connecting the combustion chamber and the throat portion.

The back pressure control unit also includes a first part shaped as a cone or truncated cone, a second part that contacts the first portion to close the flow, and an opening degree control unit for controlling the distance when the first part and the second part are separated. The first portion or the second portion may be moved by the internal pressure in the combustion chamber.

In the engines 10 that includes the plurality of combustion units 80, 100, 110, or 120, it is possible to operate one of the combustion units to supply the combustion gas 51 produced by intermittent combustion to the turbine unit 39 to rotationally drive the turbine unit 39. As one example, by operating the plurality of combustion units 80, continuously performing intermittent combustion in the respective combustion chambers 11 included in the combustion units 80, and supplying the produced combustion gas 51 to the turbine unit 39, it is possible to supply the combustion gas 51 continuously to the turbine unit 39. Here, the timing at which combustion is performed in the plurality of combustion units 80 may be simultaneous. To supply the combustion gas 51 more continuously to the turbine unit 39, it is possible to divide the plurality of combustion units 80 into a plurality of groups or form the combustion units 80 into pairs and control the timing of combustion, or to provide a phase difference by shifting the timing at which the combustion starts in order in the circumferential direction or so as to alternate in diagonal directions.

1. An engine comprising:
a gas turbine unit; and
a plurality of combustion units that supply combustion gas to the gas turbine unit,
wherein each of the plurality of combustion units includes:
a combustion chamber;
a first mechanism that moves a first wall surface that configures a part of the combustion chamber using an elastic force to reduce a volume of the combustion chamber and pressurize gas inside the combustion chamber; and
a second mechanism that opens and closes an exhaust port of the combustion chamber to control timing at which the combustion gas is discharged from the exhaust port.

2. The engine according to claim 1,
wherein the exhaust port is provided on a movement path of the first wall surface and the first mechanism also serves as the second mechanism.

3. The engine according to claim 1,
wherein each of the plurality of combustion units includes a third mechanism that holds a position of the first wall surface against the elastic force.

4. The engine according to claim 1,
wherein each of the plurality of combustion units includes a fourth mechanism that holds the position of the first wall surface against a pressure inside the combustion chamber.

5. The engine according to claim 1,
wherein each of the plurality of combustion units includes a fifth mechanism that moves the first wall surface against the elastic force in a direction where the volume of the combustion chamber expands.

6. The engine according to claim 5, further comprising:
an electric actuator that drives the fifth mechanism; and
an energy regeneration mechanism that generates electrical power using the electric actuator when the engine is running.

7. The engine according to claim 5, further comprising:
a mechanism that drives the respective fifth mechanisms of the plurality of combustion units independently.

8. The engine according to claim 1,
wherein each of the plurality of combustion units includes:
a piston that moves inside the combustion chamber and is equipped with the first wall surface that faces the combustion chamber; and
a gas supplying system for temporarily storing compressed gas that is to be supplied to the combustion chamber, in a region on an opposite side of the piston to the combustion chamber.

9. The engine according to claim 1,
wherein each of the plurality of combustion units includes a critical nozzle that connects the combustion chamber and the gas turbine unit, and
the second mechanism intermittently opens and closes a passage between the combustion chamber and a throat part of the critical nozzle.

10. The engine according to claim 1,
wherein the gas turbine unit includes a radial turbine unit, and
the plurality of combustion units are arranged around a circumference of the radial turbine unit.

11. A power generating apparatus comprising:
the engine according to claim 1; and
a generator connected to the gas turbine unit.
